(19) United States
(12) Patent Application Publication
(10) Pub. No.: US 2023/0028891 A1
(43) Pub. Date: Jan. 26, 2023

(54) Flexible Flat Cable

(71) Applicant: Ying Hao Technology CO., LTD., New Taipei (TW)

(72) Inventor: Chih-Jung Chen, New Taipei (TW)

(73) Assignee: Ying Hao Technology CO., LTD., New Taipei (TW)

(21) Appl. No.: 17/805,684

(22) Filed: Jun. 6, 2022

(30) Foreign Application Priority Data
Jul. 26, 2021 (TW) 110208772

(51) Int. Cl. H01B 7/08

(52) U.S. Cl. CPC H01B 7/0861; H01B 7/0838

(57) ABSTRACT

Embodiments of the present disclosure are directed to a flexible flat cable. Two insulating material layers are sandwiched with a plurality of conductors therebetween by two adhesive layers, and a metal shielding layer is attached to an outer side of the two insulating material layers by a laminated adhesive layer. The conductors are bare conductors, and the laminated adhesive layer is a laminated adhesive layer with bubbles. The flexible flat cable is small in size, which not only meets the requirements of characteristic impedance and insertion loss in industry, but also significantly reduces the cost compared with the conventional flexible flat cable made of traditional electronic round wires.

### CROSS REFERENCE TO RELATED APPLICATION

This application claims priority to Taiwanese Application No. 110208772, filed on Jul. 26, 2021. The entire disclosure of the above application is incorporated herein by reference.

### FIELD OF THE INVENTION

The present disclosure relates to a flexible flat cable, more particularly, to a flexible flat cable that can meet the requirements for characteristic impedance and insertion loss in industry and meet cost considerations at the same time.

### BACKGROUND

The data transmission conductor cable developed by the existing industry can be used to connect two electronic devices or two circuit boards for high-frequency data transmissions, such as a flex flat cable (FFC) or a flexible printed circuit cable. The flexible printed circuit cable is a single-sided, double-sided, and multi-layer flexible printed circuit board cable that can be produced by etching using a copper-coated substrate. The present disclosure mainly relates to a flexible flat cable. Generally, the flexible flat cable is made of insulating material layers and extremely thin flat conductors, which are pressed together by automated equipment. The flexible flat cable has the characteristics of neatly arranged cores, large transmission capacity, flat structure, small size, and flexibility and can be flexibly used in various electronic products as a data transmission conductor cable.

While using insulating materials and extremely thin flat transmission conductors pressed together by automated equipment, the flat conductors of the flexible flat cable are arranged in parallel, the upper and lower insulating material layers are attached from upper and lower sides by an adhesive layer, and the flat conductors arranged in parallel are wrapped therein when the upper and lower insulating material layers are self-adhesive at the same time. As is well known in the industry, the insulating material layer and the adhesive layer with a high dielectric constant (Dk) and high dissipation factor (DO are prone to cause signal transmission delay and signal attenuation caused by dielectric loss, so there are very high requirements for the dielectric constant (Dk) and dissipation factor (DO of the adhesive layer in direct contact with the flat conductors (in general, the lower the dielectric constant and dissipation factor, the better). Generally, the so-called “high-frequency glue” is often used, that is, when the flexible flat cable is used for high-frequency transmission, the adhesive material is still conducive to the transmission of electronic signals (the adhesive material with a low dielectric constant (Dk) value and low dissipation factor (DO). In addition, after the upper and lower insulating material layers are attached, a metal shielding layer is further attached to the outer side of the upper and lower insulating material layers with a laminated adhesive layer to completely cover the entire flexible flat cable. There are many parameters for evaluating the data transmission characteristics of the flexible flat cable, but one of the important parameters is the insertion loss.

The insertion loss refers to the ratio of the output power to the input power of the flexible flat cable and represents the remaining ratio of signal loss, and the unit is in dB. Under the requirements of a certain length in industry, it is generally possible to adjust the size of the transmission conductor, adjust the dielectric constant of the insulating material layer, adjust the material of the adhesive layer, attach the metal shielding layer to the outer side of the insulating material layer, and adjust the overall structural matching characteristics of the cable to control the insertion loss characteristics of the flexible flat cable and also adjust the characteristic impedance of the flexible flat cable.

The characteristic impedance is not a direct-current resistance but a concept in long-line transmission, and the industry generally formulates a characteristic impedance value that meets its needs. Theoretically, if the external part of the conductors is a vacuum (Dk value is 1) or air (Dk value is close to 1), there will be no insertion loss or the insertion loss will be extremely small and negligible. However, the real situation is unlikely to be the case. As far as the insulating material layer is concerned, the material close to the air the most is polytetrafluoroethylene (PTFE, commonly known as Teflon), and the Dk is 2. However, it can hardly be adhered to because of its material properties, so it cannot be used in the production of the flexible flat cable described above as the insulating material layer of the external part of the conductors. Generally speaking, the flexible flat cable industry mostly uses polyethylene terephthalate (PET or PETE, the Dk value is 3.4-3.5) as the insulating material layer.

In addition, there is another type of flexible flat cable with different structures in industry, which is discussed in the present disclosure by bonding two insulating material layers with an adhesive layer, and directly contacting a plurality of conductors arranged in parallel and wrapped therein. Take the 3M Twin Axial product as an example. The biggest difference is that it uses traditional electronic round wires to be arranged in parallel and then coats an insulating layer (e.g. Polyolefin) on the outer side. However, the biggest difference between this type of product and the flexible flat cable of the present disclosure is that the traditional electronic round wires are prefabricated. An outer side of the single wire is coaxially pre-coated with a layer of outer rubber by injection molding or other processes with insulating materials, such as cross-linked polyethylene (XLPE), and then the multiple traditional electronic round wires with outer rubber are arranged in parallel and coated upper and lower sides with insulation layers (e.g. Polyolefin, etc.) to complete the manufacture of the traditional electronic round wires. Although the high-frequency transmission effect of this type of product is good, there are still many shortcomings, not only the production process is complicated, but also the difficulty of controlling concentricity between the electronic round wire and the outer rubber is very high, and the reduction of volume of electronic round wire is limited, and the difficulty of controlling the interval between the electronic round wires is very high. This traditional electronic round wire cable has a disadvantage difficult to overcome, that is, it is expensive.

Therefore, as the connector is light, thin, short, and reasonably priced, it is bound to become the mainstream. Under this requirement, there is indeed a proposal for a flexible flat cable that can meet the specification requirements for characteristic impedance and insertion loss in industry and meet economic cost considerations at the same time, that is, the important issue that the present disclosure is eager to solve here.

### SUMMARY

In view of this, it is necessary to provide a flexible flat cable to solve the problems of the prior art.

One embodiment of the present disclosure is directed to a flexible flat cable. A plurality of bare conductors are arranged in parallel. The upper and lower insulating material layers are self-adhesive, and a metal shielding layer, such as an aluminum foil layer and a copper foil layer, is attached to at least one outer side of the upper and lower insulating material layers to complete the manufacture of the flexible flat cable of the present disclosure.

The bare conductors mentioned above of the present disclosure are preferably bare round conductors. One of the important reasons for using round conductors in the present disclosure is the skin effect. The skin effect is a phenomenon in which the current distribution inside the conductor is uneven when an alternating current or an alternating electromagnetic field occurs in the conductor. Observed from a cross-section perpendicular to the current direction, there is almost no current in the center of the conductor, and current exists only at the edge of the conductor. In short, current concentrates on the “surface” of a conductor, known as the skin effect. The main reason for the skin effect is that the changing electromagnetic field generates a vortex electric field inside the conductor, which will cancel the original current. As the distance from the conductor surface gradually increases, the current density in the conductor decays exponentially, that is, the current in the conductor will concentrate on the surface of the conductor. When the frequency is higher, the critical depth of the skin effect will be smaller, increasing the equivalent resistance. However, the creators of the present disclosure have studied hard and realized that the conventional flexible flat cables in industry mostly use flat conductors. When the transmission frequency of the flexible flat cable is higher, the electrons are not only concentrated on the “surface” of the flat conductors, but also compared to the long side of the flat conductors, the electrons are more concentrated on the surface of the short side of the flat conductors, so the use of the round conductors can more effectively utilize the skin effect, decrease the equivalent resistance of the flexible flat cable, and reduce the insertion loss of the flexible flat cable.

Furthermore, in order to adjust the characteristic impedance of the flexible flat cable to the requirements generally formulated by the industry, since the insulating material layer and the adhesive layer are in direct contact with the conductors of the flexible flat cable, the industry focuses on the selection of insulation material layers and adhesive layers with a low dielectric constant (Dk) and low dissipation factor (DO but seldom discusses the influence of the laminated adhesive layer at the outer side of the insulating materials of the metal shielding layer on insertion loss and characteristic impedance. The creators of the present disclosure have studied hard and realized that the bare round conductor is used, and the appropriate laminated adhesive layer attached to the metal shielding layer is selected at the same time, it can play a key role in the overall electrical transmission properties of the flexible flat cable, such as insertion loss and characteristic impedance.

One embodiment of the present disclosure is directed to a flexible flat cable, which comprises a plurality of bare conductors, two strip-shaped upper and lower adhesive layers, two strip-shaped upper and lower insulating material layers, at least one strip-shaped laminated adhesive layer, at least one strip-shaped metal shielding layer. The bare conductors are arranged in parallel with a fixed interval between two adjacent conductors. Based on the direction of parallel arrangement of the bare conductors, the upper and lower adhesive layers are respectively arranged on the upper and lower sides of the plane formed by the conductors, and the upper and lower insulating material layers are respectively arranged on the upper and lower sides of the upper and lower adhesive layers. In the direction perpendicular to the parallel arrangement of the bare conductors, the width of the adhesive layer and the insulating material layer is slightly larger than the width of the parallel arrangement of a plurality of round conductors. A laminated adhesive layer is arranged on at least one side of the upper and lower insulating material layers, a metal shielding layer is arranged on the upper or lower side of the laminated adhesive layer, and the widths of the bonding adhesive layer and the metal shielding layer are both equal to or smaller than the width of the insulating material layer. The bare conductors of the present disclosure are preferably bare round conductors.

Compared with the conventional flexible flat cable in the prior art using the traditional electronic round wires, the flexible flat cable of the present disclosure is small in size, which can not only meet the requirements of characteristic impedance and insertion loss in industry, but also 1/10 of the cost compared with the conventional flexible flat cable made of traditional electronic round wires, which can better meet the industry's important cost considerations.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is an insertion loss detection diagram of a flat cable with a length of 30 cm using a flat conductor by a general adhesive layer with a thickness of 0.025 mm attached to an aluminum foil layer in the prior art.

FIG. 2 is an insertion loss detection diagram of a flat cable with a length of 30 cm using a flat conductor by an acrylic adhesive layer with a thickness of 0.05 mm attached to an aluminum foil layer in the prior art.

FIG. 3 is an insertion loss detection diagram of a flat cable with a length of 30 cm using a flat conductor by an acrylic foaming adhesive layer with a thickness of 0.25 mm attached to an aluminum foil layer in the prior art.

FIG. 4A illustrates a perspective view of a flexible flat cable according to first embodiment of the present disclosure.

FIG. 4B illustrates a cross-sectional view of the flexible flat cable according to first embodiment of the present disclosure.

FIG. 4C illustrates a partial enlarged view of the flexible flat cable according to first embodiment of the present disclosure.

FIG. 4D is an insertion loss detection diagram of the flexible flat cable with a length of 30 cm using a round conductor by a general adhesive layer with a thickness of 0.025 mm attached to an aluminum foil layer according to first embodiment of the present disclosure.

FIG. 5A illustrates a perspective view of a flexible flat cable according to second embodiment of the present disclosure.

FIG. 5B illustrates a cross-sectional view of the flexible flat cable according to second embodiment of the present disclosure.

FIG. 5C illustrates a partial enlarged view of the flexible flat cable according to second embodiment of the present disclosure.

FIG. 5D is an insertion loss detection diagram of the flexible flat cable with a length of 30 cm using a round conductor by an acrylic adhesive layer with a thickness of 0.05 mm attached to an aluminum foil layer according to second embodiment of the present disclosure.

FIG. 6A illustrates a perspective view of a flexible flat cable according to third embodiment of the present disclosure.

FIG. 6B illustrates a cross-sectional view of the flexible flat cable according to third embodiment of the present disclosure.

FIG. 6C illustrates a partial enlarged view of the flexible flat cable according to third embodiment of the present disclosure.

FIG. 6D is an insertion loss detection diagram of the flexible flat cable with a length of 30 cm using a round conductor by an acrylic foaming adhesive layer with a thickness of 0.025 mm attached to an aluminum foil layer according to third embodiment of the present disclosure.

### DESCRIPTION OF THE EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

It should further be understood that, although the terms first, second, third, and the like may be used herein to describe various elements, components, regions, layers and/or sections, these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

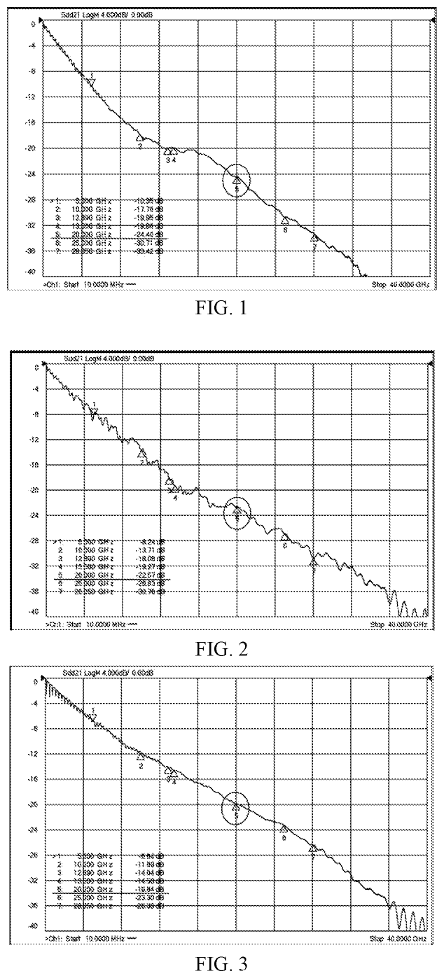

Please refer to FIGS. 1 to 3. FIG. 1 is an insertion loss detection diagram of a flat cable with a length of 30 cm using a flat conductor by “a general adhesive layer” with a thickness of 0.025 mm attached to an aluminum foil layer in the prior art. FIG. 2 is an insertion loss detection diagram of a flat cable with a length of 30 cm using a flat conductor by “an acrylic adhesive layer” with a thickness of 0.05 mm attached to an aluminum foil layer in the prior art. FIG. 3 is an insertion loss detection diagram of a flat cable with a length of 30 cm using a flat conductor by “an acrylic foaming adhesive layer” with a thickness of 0.25 mm attached to an aluminum foil layer in the prior art. FIGS. 1 to 3 are the results obtained when other structural conditions of the flexible flat cable are the same.

The flat conductor known in industry is used as the signal transmission medium of the flexible flat cable in the prior art. The width of a single flat conductor is 0.3 mm, the interval between the flat conductors is 0.5 mm, and “a general adhesive layer” with a thickness of 0.025 mm is used, which as a laminated adhesive layer to attach to the aluminum foil layer. As shown in FIG. 1, when the frequency of the transmission signal is increased to 20 GHz, the detected insertion loss is −24.40 dB.

The flat conductor known in industry is used as the signal transmission medium of the flexible flat cable in the prior art. The width of a single flat conductor is 0.3 mm, the interval between the flat conductors is 0.5 mm, and “an acrylic adhesive layer” with a thickness of 0.05 mm is used, which as a laminated adhesive layer to attach to the aluminum foil layer. As shown in FIG. 2, when the frequency of the transmission signal is increased to 20 GHz, the detected insertion loss is −22.57 dB.

The flat conductor known in industry is used as the signal transmission medium of the flexible flat cable in the prior art. The width of a single flat conductor is 0.3 mm, the interval between the flat conductors is 0.5 mm, and a laminated adhesive layer with bubbles (e.g. an acrylic foaming adhesive layer) with a thickness of 0.25 mm is used, which as a laminated adhesive layer to attach to the aluminum foil layer. As shown in FIG. 3, when the frequency of the transmission signal is increased to 20 GHz, the detected insertion loss is −19.84 dB.

It can be seen from the above that through the selection and improvement of the laminated adhesive layer, the signal insertion loss caused by the increase of the transmission signal frequency can be significantly reduced (the insertion loss has been improved from −24.40 dB to −19.84 dB) and make the signal of the flexible flat cable have a more linear insertion loss, which can be used to predict the high linear characteristics rather than the unstable non-linear characteristics.

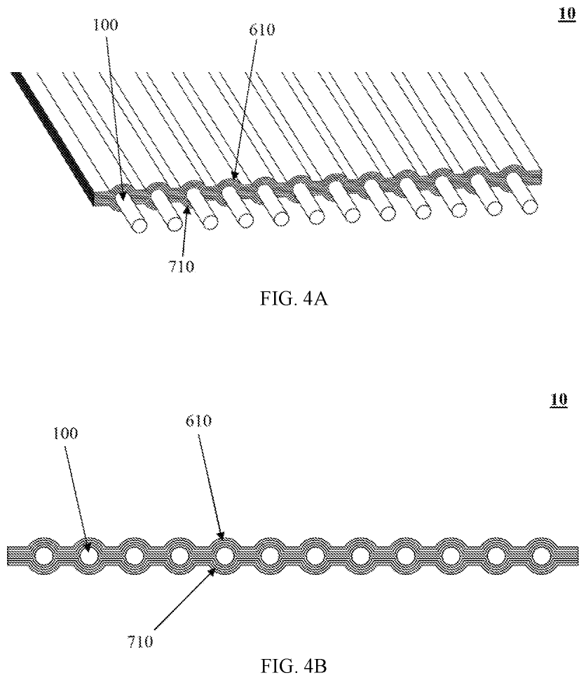

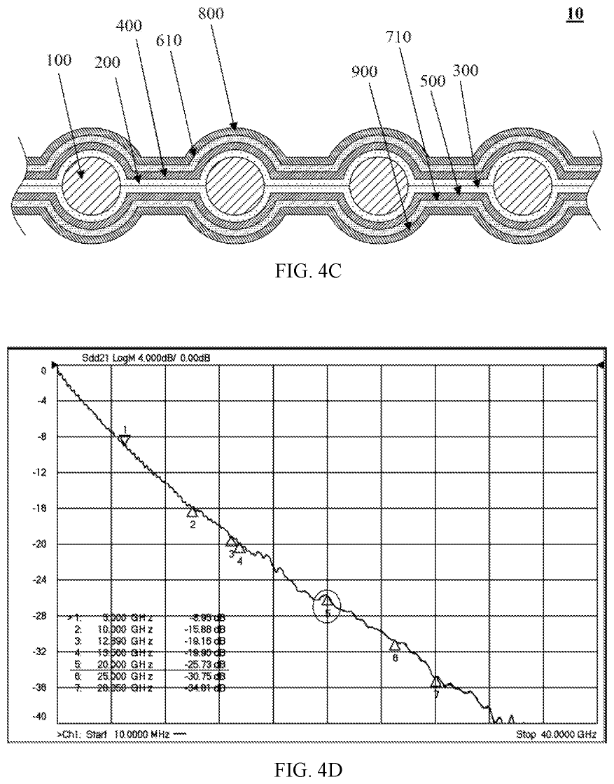

Please refer to FIGS. 4A to 4C according to first embodiment of the present disclosure. FIG. 4A illustrates a perspective view of a flexible flat cable 10 according to first embodiment of the present disclosure. FIG. 4B illustrates a cross-sectional view of the flexible flat cable 10 according to first embodiment of the present disclosure. FIG. 4C illustrates a partial enlarged view of the flexible flat cable 10 according to first embodiment of the present disclosure. FIG. 4D is an insertion loss detection diagram of the flexible flat cable 10 with a length of 30 cm using a round conductor by “a general adhesive layer” with a thickness of 0.025 mm attached to an aluminum foil layer according to first embodiment of the present disclosure.

Please refer to FIGS. 4A, 4B, and 4C. The flexible flat cable 10 of the present disclosure comprises a plurality of bare round conductors 100, an upper adhesive layer 200, a lower adhesive layer 300, an upper insulating material layer 400, a lower insulating material layer 500, an upper laminated adhesive layer 610, a lower laminated adhesive layer 710, an upper metal shielding layer 800, and a lower metal shielding layer 900. The diameter of the bare round conductors 100 is 0.2 mm as an example. The bare round conductors 100 illustrated in each of the figures are drawn with a certain tension applied on both sides to enable them to control the interval between the bare round conductors very accurately, and the interval is 0.5 mm as an example. Next, the upper adhesive layer 200 may be pre-adhered to the upper insulating material layer 400, the lower adhesive layer 300 may be pre-adhered to the lower insulating material layer 300, and then the upper insulating material layer 400 and the lower insulating material layer 500 are respectively placed above and below the bare round conductors 100, the upper adhesive layer 200 and the lower adhesive layer 300 face the bare round conductors 100 and are pressed by a fixture or automated equipment, so that the bare round conductors 100 are precisely maintained at an interval of 0.5 mm in this state and pressed and glued therein. Next, the upper laminated adhesive layer 610 and the lower laminated adhesive layer 710 are “general adhesive layers” with a thickness of 0.025 mm, the upper metal shielding layer 800 and the lower metal shielding layer 900 may be aluminum foil layers or copper foil layers, and the upper laminated adhesive layer 610 may be pre-adhered to the upper metal shielding layer 800, the lower laminated adhesive layer 710 may be pre-adhered to the lower metal shielding layer 900, and then the upper metal shielding layer 800 and the lower metal shielding layer 900 are respectively placed above and below the upper insulating material layer 400 and the lower insulating material layer 500 and pressed together by a fixture or automated equipment, so that the upper metal shielding layer 800 and the lower metal shielding layer 900 are attached to the surfaces of the upper insulating material layer 400 and the lower insulating material layer 500 to complete the manufacture of the flexible flat cable 10.

Of course, the bare round conductors 100, the upper adhesive layer 200, the lower adhesive layer 300, the upper insulating material layer 400, the lower insulating material layer 500, the upper laminated adhesive layer 610, the lower laminated adhesive layer 710, the upper metal shielding layer 800, and the lower metal shielding layer 900 can also be made into strips of the present disclosure, and the flexible flat cable 10 can be manufactured in a single step or multiple steps through an automated process of rolling out and rolling in.

As shown in FIGS. 4A, 4B, and 4C, the bare round conductors 100 are used as the signal transmission medium of the flexible flat cable 10. The diameter of a single round conductor is preferably 0.1 mm to 0.4 mm. In this embodiment, 0.2 mm is used as an example. The interval between the round conductors is 0.3 mm to 1.0 mm. In this embodiment, 0.5 mm is used as an example. “A general adhesive layer” with a thickness of 0.025 mm is used as the upper laminated adhesive layer 610 and the lower laminated adhesive layer 710, which are attached to the upper metal shielding layer 800 (an aluminum foil layer or copper foil layer) and the lower metal shielding layer 900 (an aluminum foil layer or copper foil layer). As shown in FIG. 4D, when the frequency of the transmission signal is increased to 20 GHz, the detected insertion loss is −25.73 dB. From the test results, it can be known that the use of bare round conductors as the signal transmission medium of the flexible flat cable can obviously make the signal insertion loss of the flexible flat cable more linear. However, only using general glue as the upper laminated adhesive layer 610 and the lower laminated adhesive layer 710 still has a poor insertion loss of −25.73 dB/20 GHz.

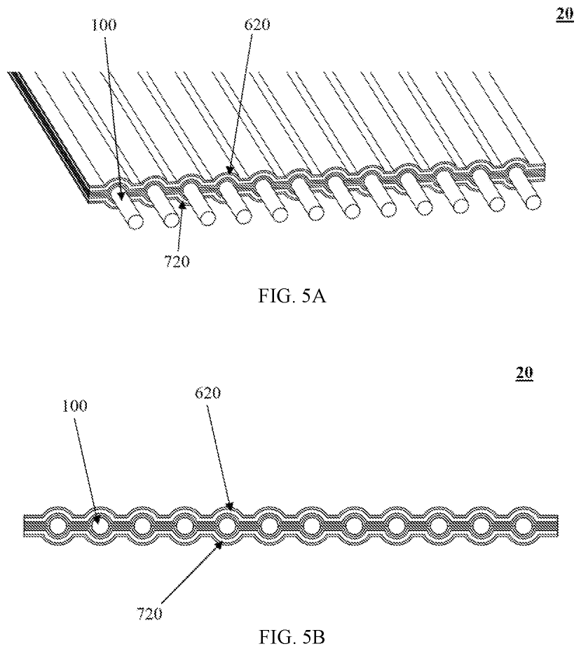

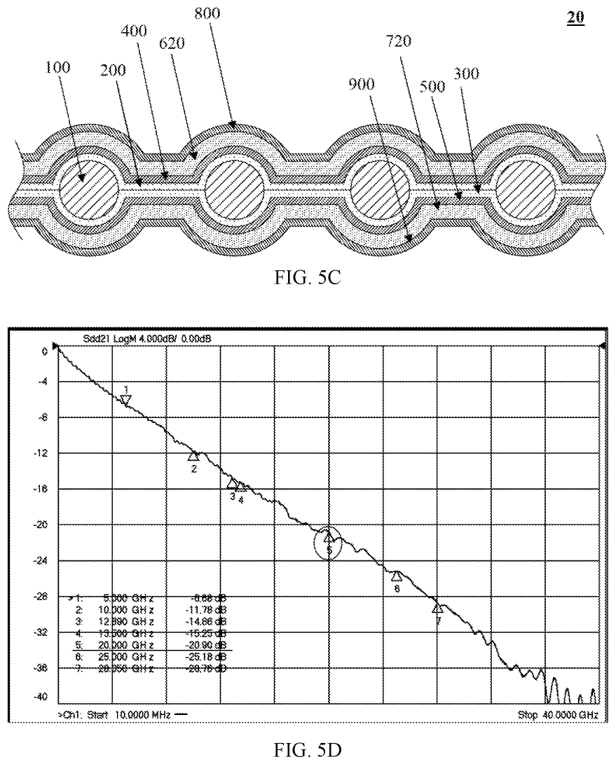

Please refer to FIGS. 5A to 5C according to second embodiment of the present disclosure. FIG. 5A illustrates a perspective view of a flexible flat cable 20 according to second embodiment of the present disclosure. FIG. 5B illustrates a cross-sectional view of the flexible flat cable 20 according to second embodiment of the present disclosure. FIG. 5C illustrates a partial enlarged view of the flexible flat cable 20 according to second embodiment of the present disclosure. FIG. 5D is an insertion loss detection diagram of the flexible flat cable 20 with a length of 30 cm using a round conductor by “an acrylic adhesive layer” with a thickness of 0.05 mm attached to an aluminum foil layer according to second embodiment of the present disclosure.

Please refer to FIGS. 5A, 5B, and 5C, The flexible flat cable 20 of the present disclosure comprises a plurality of bare round conductors 100, an upper adhesive layer 200, a lower adhesive layer 300, an upper insulating material layer 400, a lower insulating material layer 500, an upper laminated adhesive layer 620, a lower laminated adhesive layer 720, an upper metal shielding layer 800, and a lower metal shielding layer 900. The diameter of the bare round conductors 100 is 0.2 mm as an example. The bare round conductors 100 illustrated in each of the figures are drawn with a certain tension applied on both sides to enable them to control the interval between the bare round conductors very accurately, and the interval is 0.5 mm as an example. Next, the upper adhesive layer 200 may be pre-adhered to the upper insulating material layer 400, the lower adhesive layer 300 may be pre-adhered to the lower insulating material layer 300, and then the upper insulating material layer 400 and the lower insulating material layer 500 are respectively placed above and below the bare round conductors 100, the upper adhesive layer 200 and the lower adhesive layer 300 face the bare round conductors 100 and are pressed by a fixture or automated equipment, so that the bare round conductors 100 are precisely maintained at an interval of 0.5 mm in this state and pressed and glued therein. Next, the upper laminated adhesive layer 620 and the lower laminated adhesive layer 720 are “acrylic adhesive layers” with a thickness of 0.05 mm, the upper metal shielding layer 800 and the lower metal shielding layer 900 may be aluminum foil layers or copper foil layers, and the upper laminated adhesive layer 620 may be pre-adhered to the upper metal shielding layer 800, the lower laminated adhesive layer 720 may be pre-adhered to the lower metal shielding layer 900, and then the upper metal shielding layer 800 and the lower metal shielding layer 900 are respectively placed above and below the upper insulating material layer 400 and the lower insulating material layer 500 and pressed together by a fixture or automated equipment, so that the upper metal shielding layer 800 and the lower metal shielding layer 900 are attached to the surfaces of the upper insulating material layer 400 and the lower insulating material layer 500 to complete the manufacture of the flexible flat cable 20.

Of course, the bare round conductors 100, the upper adhesive layer 200, the lower adhesive layer 300, the upper insulating material layer 400, the lower insulating material layer 500, the upper laminated adhesive layer 620, the lower laminated adhesive layer 720, the upper metal shielding layer 800, and the lower metal shielding layer 900 can also be made into strips of the present disclosure, and the flexible flat cable 20 can be manufactured in a single step or multiple steps through an automated process of rolling out and rolling in.

As shown in FIGS. 5A, 5B, and 5C, the bare round conductors 100 are used as the signal transmission medium of the flexible flat cable 20. The diameter of a single round conductor is preferably 0.1 mm to 0.4 mm. In this embodiment, 0.2 mm is used as an example, and the interval between the round conductors is 0.3 mm to 1.0 mm. In this embodiment, 0.5 mm is used as an example. “An acrylic adhesive layer” with a thickness of 0.05 mm is used as the upper laminated adhesive layer 620 and the lower laminated adhesive layer 720, which are attached to the upper metal shielding layer 800 (an aluminum foil layer or copper foil layer) and the lower metal shielding layer 900 (an aluminum foil layer or copper foil layer). As shown in FIG. 5D, when the frequency of the transmission signal is increased to 20 GHz, the detected insertion loss is −20.90 dB. From the test results, it can be known that the use of bare round conductors as the signal transmission medium of the flexible flat cable can obviously make the signal insertion loss of the flexible flat cable more linear. However, only using acrylic glue as the upper laminated adhesive layer 620 and the lower laminated adhesive layer 720 still has a slight improved insertion loss of −20.90 dB/20 GHz.

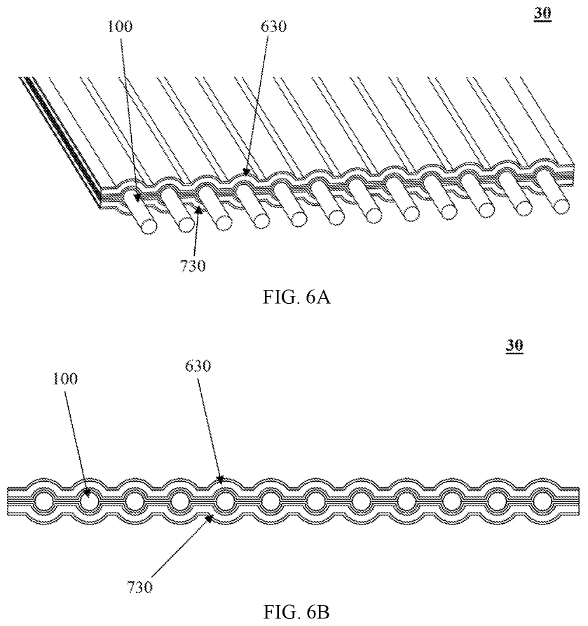

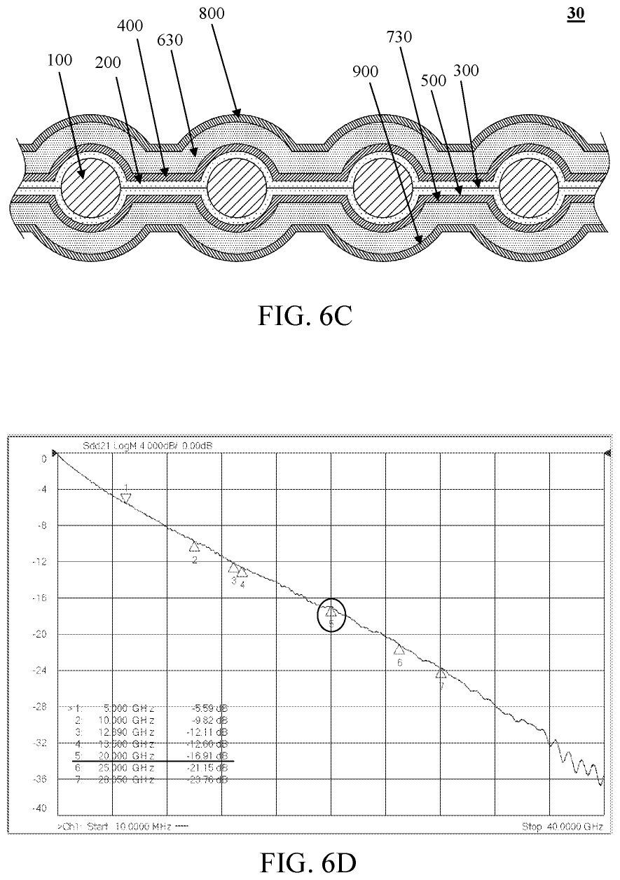

Please refer to FIGS. 6A to 6C according to second embodiment of the present disclosure. FIG. 6A illustrates a perspective view of a flexible flat cable 30 according to third embodiment of the present disclosure. FIG. 6B illustrates a cross-sectional view of the flexible flat cable 30 according to third embodiment of the present disclosure. FIG. 6C illustrates a partial enlarged view of the flexible flat cable 30 according to third embodiment of the present disclosure. FIG. 6D is an insertion loss detection diagram of the flexible flat cable 30 with a length of 30 cm using a round conductor by a laminated adhesive layer with bubbles (e.g. an acrylic foaming adhesive layer) with a thickness of 0.025 mm attached to an aluminum foil layer according to third embodiment of the present disclosure.

Please refer to FIGS. 6A, 6B, and 6C. The flexible flat cable 30 of the present disclosure comprises a plurality of bare round conductors 100, an upper adhesive layer 200, a lower adhesive layer 300, an upper insulating material layer 400, a lower insulating material layer 500, an upper laminated adhesive layer 630, a lower laminated adhesive layer 730, an upper metal shielding layer 800, and a lower metal shielding layer 900. The diameter of the bare round conductors 100 is 0.2 mm as an example. The bare round conductors 100 illustrated in each of the figures are drawn with a certain tension applied on both sides to enable them to control the interval between the bare round conductors very accurately, and the interval is 0.5 mm as an example. Next, the upper adhesive layer 200 may be pre-adhered to the upper insulating material layer 400, the lower adhesive layer 300 may be pre-adhered to the lower insulating material layer 300, and then the upper insulating material layer 400 and the lower insulating material layer 500 are respectively placed above and below the bare round conductors 100, the upper adhesive layer 200 and the lower adhesive layer 300 face the bare round conductors 100 and are pressed by a fixture or automated equipment, so that the bare round conductors 100 are precisely maintained at an interval of 0.5 mm in this state and pressed and glued therein. Next, the upper laminated adhesive layer 630 and the lower laminated adhesive layer 730 are laminated adhesive layers with bubbles (e.g. acrylic foaming adhesive layers) with a thickness of 0.025 mm, the upper metal shielding layer 800 and the lower metal shielding layer 900 may be aluminum foil layers or copper foil layers, and the upper laminated adhesive layer 630 may be pre-adhered to the upper metal shielding layer 800, the lower laminated adhesive layer 730 may be pre-adhered to the lower metal shielding layer 900, and then the upper metal shielding layer 800 and the lower metal shielding layer 900 are respectively placed above and below the upper insulating material layer 400 and the lower insulating material layer 500 and pressed together by a fixture or automated equipment, so that the upper metal shielding layer 800 and the lower metal shielding layer 900 are attached to the surfaces of the upper insulating material layer 400 and the lower insulating material layer 500 to complete the manufacture of the flexible flat cable 30.

The bare round conductors 100, the upper adhesive layer 200, the lower adhesive layer 300, the upper insulating material layer 400, the lower insulating material layer 500, the upper laminated adhesive layer 630, the lower laminated adhesive layer 730, the upper metal shielding layer 800, and the lower metal shielding layer 900 can also be made into strips of the present disclosure, and the flexible flat cable 30 can be manufactured in a single step or multiple steps through an automated process of rolling out and rolling in.

As shown in FIGS. 6A, 6B, and 6C, the bare round conductors 100 are used as the signal transmission medium of the flexible flat cable 10. The diameter of a single round conductor is preferably 0.1 mm to 0.4 mm. In this embodiment, 0.2 mm is used as an example. The interval between the round conductors is 0.3 mm to 1.0 mm. In this embodiment, 0.5 mm is used as an example. A laminated adhesive layer with bubbles (e.g. an acrylic foaming adhesive layer) with a thickness of 0.025 mm is used as the upper laminated adhesive layer 630 and the lower laminated adhesive layer 730, which are attached to the upper metal shielding layer 800 (an aluminum foil layer or copper foil layer) and the lower metal shielding layer 900 (an aluminum foil layer or copper foil layer). As shown in FIG. 6D, when the frequency of the transmission signal is increased to 20 GHz, the detected insertion loss is −16.91 dB. From the test results, the use of bare round conductors as the signal transmission medium of the flexible flat cable can obviously make the signal insertion loss of the flexible flat cable more linear. The measured results are as shown in FIG. 6D and have approached a straight line. By using the laminated adhesive layer with bubbles (e.g. acrylic foaming adhesive layer) as the upper laminated adhesive layer 630 and the lower laminated adhesive layer 730, the insertion loss of the flexible flat cable 30 can be significantly reduced to −16.91 dB/20 GHz. In addition, it has been tested that the characteristic impedance of the flexible flat cable 30 can better maintain the value required.

The laminated adhesive layer with bubbles is not limited to the acrylic foaming layer, but only the laminated adhesive layer with pores, air pockets, or bubbles mixed with air by chemical or mechanical processing should theoretically be able to obtain test results similar to the previous test results of the present disclosure. In particular, the comparison of the detection results obtained by the acrylic adhesive layer used in the second embodiment and the acrylic foaming adhesive layer used in the third embodiment can be clearly understood. It can be known from the detection results of the prior art in FIGS. 1 to 3 and the various embodiments in FIGS. 4D, 5D, and 6D that the author has studied the skin effect of bare round wires, and realized the selection of the laminated adhesive layer with bubbles not only reduces the equivalent resistance value but also significantly reduces the insertion loss of the flexible flat cable at the same time. Meanwhile, it can better maintain the standard value of the characteristic impedance required by the industry.

Compared with the existing flexible flat cable using the traditional electronic round wire in the prior art, the flexible flat cable of the present disclosure is small in size, which can not only meet the requirements of characteristic impedance and insertion loss in industry, but also 1/10 of the cost or even lower compared with the conventional flexible flat cable made of traditional electronic round wires, which can quite meet the industry's important cost considerations. The signal of the flexible flat cable of the present disclosure has a more linear insertion loss, which can be used to predict the high linear characteristics rather than the unstable non-linear characteristics.

While the embodiments of the present disclosure have been shown and described above, it is to be understood that the above embodiments are exemplary and are not to be construed as limiting the present disclosure. One of ordinary skill in the art may make variations, modifications, substitutions and alterations to the above embodiments within the scope of the present disclosure.

What is claimed is:

1. A flexible flat cable, comprising:
a plurality of bare conductors, arranged in parallel with a fixed interval between two adjacent conductors;
a strip-shaped upper adhesive layer, located above the conductors;
a strip-shaped lower adhesive layer, located below the conductors;
a strip-shaped upper insulating material layer, located above the upper adhesive layer;
a strip-shaped lower insulating material layer, located below the lower adhesive layer;
a strip-shaped laminated adhesive layer; and
at least one strip-shaped metal shielding layer, located above the upper insulating material layer or below the lower insulating material layer and attached to an upper side of the upper insulating material layer or a lower side of the lower insulating material layer by the laminated adhesive layer;
wherein the upper insulating material and the lower insulating material layer are sandwiched with the conductors therebetween by the upper adhesive layer and the lower adhesive layer.

2. The flexible flat cable as claimed in claim 1, wherein the conductors are round conductors.

3. The flexible flat cable as claimed in claim 2, wherein a diameter of the conductors is 0.1 mm to 0.4 mm.

4. The flexible flat cable as claimed in claim 2, wherein the fixed interval of the round conductors is 0.3 mm to 1.0 mm.

5. The flexible flat cable as claimed in claim 1, wherein the laminated adhesive layer is a laminated adhesive layer with bubbles.

6. The flexible flat cable as claimed in claim 5, wherein the laminated adhesive layer with bubbles is an acrylic foaming adhesive layer.

7. The flexible flat cable as claimed in claim 1, wherein a thickness of the laminated adhesive layer is 0.1 mm to 0.4 mm.

8. The flexible flat cable as claimed in claim 1, wherein the metal shielding layer is an aluminum foil layer or a copper foil layer.

9. The flexible flat cable as claimed in claim 1, further comprising a second metal shielding layer attached to the lower side of the lower insulating material layer or the upper side of the upper insulating material layer with another adhesive layer.

10. A flexible flat cable, comprising:
a plurality of bare conductors arranged in parallel, wherein a strip-shaped plane with a rectangular area is formed, and a fixed interval is disposed between two adjacent conductors used for transmitting electrical signals;
an upper adhesive layer, shaped as a strip corresponding to the rectangular area;
a lower adhesive layer, shaped as a strip corresponding to the rectangular area;
an upper insulating material layer, shaped as a strip corresponding to the rectangular area;
a lower insulating material layer, shaped as a strip corresponding to the rectangular area and sandwiched the conductors therebetween with the upper insulating material layer by the upper adhesive layer and the lower adhesive layer;
a metal shielding layer, attached to an upper side of the upper insulating material layer or a lower side of the lower insulating material layer by a laminated adhesive layer.

11. The flexible flat cable as claimed in claim 10, wherein the conductors are round conductors.

12. The flexible flat cable as claimed in claim 11, wherein a diameter of the conductors is 0.1 mm to 0.4 mm.

13. The flexible flat cable as claimed in claim 11, wherein the fixed interval of the round conductors is 0.3 mm to 1.0 mm.

14. The flexible flat cable as claimed in claim 10, wherein the laminated adhesive layer is a laminated adhesive layer with bubbles.

15. The flexible flat cable as claimed in claim 14, wherein the laminated adhesive layer with bubbles is an acrylic foaming adhesive layer.

16. The flexible flat cable as claimed in claim 10, wherein a thickness of the laminated adhesive layer is 0.1 mm to 0.4 mm.

17. The flexible flat cable as claimed in claim 10, wherein the metal shielding layer is an aluminum foil layer or a copper foil layer.

18. The flexible flat cable as claimed in claim 10, further comprising a second metal shielding layer attached to the lower side of the lower insulating material layer or the upper side of the upper insulating material layer with another adhesive layer.

19. A flexible flat cable, comprising:
two insulating material layers;
a plurality of conductors, sandwiched by the two insulating material layers with two adhesive layers; and
a metal shielding layer, attached to an outer side of the two insulating material layers by a laminated adhesive layer, wherein the laminated adhesive layer is a laminated adhesive layer with bubbles;
wherein two adjacent conductors are separated with a fixed interval.

20. The flexible flat cable as claimed in claim 19, wherein the conductors are round conductors.

21. The flexible flat cable as claimed in claim 19, wherein the laminated adhesive layer with bubbles is an acrylic foaming adhesive layer.

22. The flexible flat cable as claimed in claim 20, wherein a diameter of the conductors is 0.1 mm to 0.4 mm.

23. The flexible flat cable as claimed in claim 20, wherein the fixed interval of the round conductors is 0.3 mm to 1.0 mm.

24. The flexible flat cable as claimed in claim 19, wherein a thickness of the laminated adhesive layer is 0.1 mm to 0.4 mm.

25. The flexible flat cable as claimed in claim 19, wherein the metal shielding layer is an aluminum foil layer or a copper foil layer.

26. The flexible flat cable as claimed in claim 19, further comprising a second metal shielding layer attached to another side of the two insulating material layers with another adhesive layer.
